(19) United States
(12) Patent Application Publication
(10) Pub. No.: US 2012/0276376 A1
(43) Pub. Date: Nov. 1, 2012

(54) PRESSURE-SENSITIVE ADHESIVE SHEET AND METHOD FOR PRODUCING THE SAME

(75) Inventor: Kousuke YONEZAKI, Osaka (JP)

(73) Assignee: NITTO DENKO CORPORATION, Osaka (JP)

(21) Appl. No.: 13/456,667

(22) Filed: Apr. 26, 2012

(30) Foreign Application Priority Data
Apr. 27, 2011 (JP) 2011-099881

(51) Int. Cl. C09J 7/02; C08J 7/04

(52) U.S. Cl. 428/345; 427/505

(57) ABSTRACT

The present invention relates to a pressure-sensitive adhesive sheet containing a substrate and a pressure-sensitive adhesive layer formed on at least one side of the substrate, in which the pressure-sensitive adhesive layer is obtained by heating and drying an aqueous dispersion pressure-sensitive adhesive composition containing an acrylic emulsion polymer A and a compound B having, in the molecule, one or more electron beam reactive groups and one or more isocyanate groups to form a pre-irradiation pressure-sensitive adhesive layer, and irradiating the pre-irradiation pressure-sensitive adhesive layer with an electron beam.

### TECHNICAL FIELD

The present invention relates to a pressure-sensitive adhesive sheet. More specifically, the present invention relates to a pressure-sensitive adhesive sheet comprising a substrate having on at least one side thereof a pressure-sensitive adhesive layer formed of an aqueous dispersion pressure-sensitive adhesive composition.

### BACKGROUND ART

Generally, in use as a double-coated pressure-sensitive adhesive sheet, a pressure-sensitive adhesive sheet of a type having a pressure-sensitive adhesive layer on a substrate (a substrate-attached-type pressure-sensitive adhesive sheet, a substrate-attached pressure-sensitive adhesive sheet) cannot maintain its function when lifting or separation occurs after application to an adherend. Also, with a recent increase in the demand for optical products, the amount of a pressure-sensitive adhesive sheet used for the optical products is increasing rapidly. In particular, low contamination property is important in the usage for an optical product and therefore, when an adhesive deposit is generated on an adherend at the time of separating the pressure-sensitive adhesive sheet for optical products after its application to the adherend, this becomes a fatal defect. Accordingly, a substrate-attached type-pressure-sensitive adhesive sheet, in which the pressure-sensitive adhesive layer exerts a sufficient anchoring force to the substrate, is demanded.

Also, as for the substrate-attached pressure-sensitive adhesive sheet, in view of environment and safety, a pressure-sensitive adhesive sheet having, on a substrate, a pressure-sensitive adhesive layer formed by coating and drying an aqueous dispersion pressure-sensitive adhesive composition is used (see, Patent Documents 1 and 2). In this substrate-attached pressure-sensitive adhesive sheet, at the time of forming a pressure-sensitive adhesive layer on a substrate by using an aqueous dispersion pressure-sensitive adhesive composition, a substrate subjected to a surface treatment such as corona treatment or undercoating treatment in a separate step is used. However, in the substrate-attached pressure-sensitive adhesive sheet above, a sufficient anchoring force between the pressure-sensitive adhesive layer and the substrate cannot be obtained in some cases due to an emulsifier contained in the aqueous dispersion pressure-sensitive adhesive composition. For this reason, when the substrate-attached pressure-sensitive adhesive sheet is applied to an adherend and then separated therefrom, an adhesive deposit is generated on the adherend in some cases, or when the substrate-attached pressure-sensitive adhesive sheet is applied to an adherend, lifting or separation from the adherend occurs in some cases.

Patent Document 1: JP-A-2001-152116

Patent Document 2: JP-A-2007-171892

### SUMMARY OF THE INVENTION

Accordingly, an object of the present invention is to provide a pressure-sensitive adhesive sheet having a pressure-sensitive adhesive layer which is formed of an aqueous dispersion pressure-sensitive adhesive composition and exerts a sufficient anchoring force to the substrate.

As a result of intensive studies, the present inventors have found that when a layer obtained by heating and drying an aqueous dispersion pressure-sensitive adhesive composition containing at least an acrylic emulsion polymer and a specific compound is provided on a substrate and then irradiated with an electron beam, a pressure-sensitive adhesive sheet having a pressure-sensitive adhesive layer exerting a sufficient anchoring force to the substrate can be obtained. The present invention has been accomplished based on this finding.

Accordingly, the present invention provides a pressure-sensitive adhesive sheet containing a substrate and a pressure-sensitive adhesive layer formed on at least one side of the substrate, in which the pressure-sensitive adhesive layer is obtained by heating and drying an aqueous dispersion pressure-sensitive adhesive composition containing an acrylic emulsion polymer A and a compound B having, in the molecule, one or more electron beam reactive groups and one or more isocyanate groups to form a pre-irradiation pressure-sensitive adhesive layer, and irradiating the pre-irradiation pressure-sensitive adhesive layer with an electron beam.

The electron beam reactive group is preferably a radical polymerizable group, and the radical polymerizable group is preferably an unsaturated bond group.

Further, the aqueous dispersion pressure-sensitive adhesive composition preferably contains the compound B in an amount of from 0.1 to 30 parts by weight, and more preferably from 0.3 to 10 parts by weight, based on 100 parts by weight of the acrylic emulsion polymer A.

Further, the present invention provides a method for producing a pressure-sensitive adhesive sheet by forming a pressure-sensitive adhesive layer on at least one side of a substrate, in which the production method containing the following steps 1, 2 and 3:

step 1: a step of forming an aqueous dispersion pressure-sensitive adhesive composition layer from an aqueous dispersion pressure-sensitive adhesive composition containing an acrylic emulsion polymer A and a compound B having, in the molecule, one or more electron beam reactive groups and one or more isocyanate groups;

step 2: a step of heating and drying the aqueous dispersion pressure-sensitive adhesive composition layer to form a pre-irradiation pressure-sensitive adhesive layer; and

step 3: a step of irradiating the pre-irradiation pressure-sensitive adhesive layer provided on at least one side of the substrate with an electron beam to form the pressure-sensitive adhesive layer.

Further, the present invention provides a method for producing a pressure-sensitive adhesive sheet, containing:

forming, on at least one side of a substrate, an aqueous dispersion pressure-sensitive adhesive composition layer from an aqueous dispersion pressure-sensitive adhesive composition containing an acrylic emulsion polymer A and a compound B having, in the molecular, one or more electron beam reactive groups and one or more isocyanate groups,

heating and drying the aqueous dispersion pressure-sensitive adhesive composition layer to form a pre-irradiation pressure-sensitive adhesive layer, and

irradiating the pre-irradiation pressure-sensitive adhesive layer with an electron beam to form a pressure-sensitive adhesive layer.

Further, the present invention provides a method for producing a pressure-sensitive adhesive sheet, containing:

forming, on a separator, an aqueous dispersion pressure-sensitive adhesive composition layer from an aqueous dispersion pressure-sensitive adhesive composition containing an acrylic emulsion polymer A and a compound B having, in the molecular, one or more electron beam reactive groups and one or more isocyanate groups;

heating and drying the aqueous dispersion pressure-sensitive adhesive composition layer to form a pre-irradiation pressure-sensitive adhesive layer;

transferring the pre-irradiation pressure-sensitive adhesive layer onto at least one side of a substrate; and thereafter

irradiating the pre-irradiation pressure-sensitive adhesive layer with an electron beam to form a pressure-sensitive adhesive layer.

The pressure-sensitive adhesive sheet of the present invention has the above-descried configurations and therefore is excellent in anchoring force between a substrate and a pressure-sensitive adhesive layer, in spite of the pressure-sensitive adhesive layer is formed of an aqueous dispersion pressure-sensitive adhesive composition. Accordingly, the pressure-sensitive adhesive sheet of the present invention is excellent in adhesive deposit prevention and resistance to lifting or peeling.

### MODE FOR CARRYING OUT THE INVENTION

The pressure-sensitive adhesive sheet of the present invention has, on at least one side of a substrate, a pressure-sensitive adhesive layer (adhesive layer) obtained by heating and drying an aqueous dispersion pressure-sensitive adhesive composition to form a layer, and curing the formed layer with an electron beam. The aqueous dispersion pressure-sensitive adhesive composition above contains at least an acrylic emulsion polymer A and a compound B having, in the molecule, one or more electron beam reactive groups and one or more isocyanate groups. In the present invention, the “pressure-sensitive adhesive layer obtained by heating and drying an aqueous dispersion pressure-sensitive adhesive composition containing an acrylic emulsion polymer A and a compound B having, in the molecule, one or more electron beam reactive groups and one or more isocyanate groups to form a layer, and curing the formed layer with an electron beam” is sometimes referred to as the “pressure-sensitive adhesive layer of the present invention”. Also, the “compound B having, in the molecule, one or more electron beam reactive groups and one or more isocyanate groups” is sometimes referred to as an “isocyanate compound B”. Furthermore, the layer of the aqueous dispersion pressure-sensitive adhesive composition is sometimes referred to as an “aqueous dispersion pressure-sensitive adhesive composition layer”. In addition, the layer formed by heating and drying the aqueous dispersion pressure-sensitive adhesive composition (the layer formed by heating and drying the aqueous dispersion pressure-sensitive adhesive composition layer) is sometimes referred to as a “pre-irradiation pressure-sensitive adhesive layer”.

The pressure-sensitive adhesive sheet of the present invention is a substrate-attached type-pressure-sensitive adhesive sheet having the pressure-sensitive adhesive layer of the present invention on at least one side of a substrate.

The pressure-sensitive adhesive sheet of the present invention may be a single-coated pressure-sensitive adhesive sheet in a configuration having the pressure-sensitive adhesive layer of the present invention on one side of a substrate. Also, the pressure-sensitive adhesive sheet of the present invention may be a double-coated pressure-sensitive adhesive sheet in a configuration having the pressure-sensitive adhesive layer of the present invention on both sides of a substrate, or a double-coated pressure-sensitive adhesive sheet in a configuration having the pressure-sensitive adhesive layer of the present invention on one side of a substrate and having another pressure-sensitive adhesive layer (a pressure-sensitive adhesive layer other than the pressure-sensitive adhesive of the present invention) on the other side of the substrate.

### (Pressure-Sensitive Adhesive Layer of the Present Invention)

The pressure-sensitive adhesive layer of the present invention is formed by heating and drying an aqueous dispersion pressure-sensitive adhesive composition containing an acrylic emulsion polymer A and an isocyanate compound B to form a layer (pre-irradiation pressure-sensitive adhesive layer), and irradiating the formed layer with an electron beam.

The acrylic emulsion polymer A is a polymer formed by using an acrylic monomer as an essential raw material monomer (raw material monomer component). The acrylic emulsion polymer A may be a polymer formed of a monomer mixture containing an acrylic monomer as an essential component. The monomer mixture is a composition consisting of only monomer components and containing at least one or more monomers. In the aqueous dispersion pressure-sensitive adhesive composition, as for the acrylic emulsion polymer A, one polymer is used alone or two or more polymers are used in combination. Here, the “(meth)acryl” indicates “acryl” and/or “methacryl”.

In particular, the acrylic monomer is preferably a (meth)acrylic acid alkyl ester.

The (meth)acrylic acid alkyl ester is used as a main monomer component of the acrylic emulsion polymer A and fulfills a role mainly to develop basic characteristics as a pressure-sensitive adhesive (or a pressure-sensitive adhesive layer), such as adhesiveness and releasability. Of these, the acrylic acid alkyl ester tends to produce an effect of imparting flexibility to polymer forming a pressure-sensitive adhesive layer and letting the pressure-sensitive adhesive layer develop adherence or adhesive property, and the methacrylic acid alkyl ester tends to produce an effect of imparting hardness to polymer forming a pressure-sensitive adhesive layer and adjusting removability of the pressure-sensitive adhesive layer. The (meth)acrylic acid alkyl ester is not particularly limited, but examples thereof include a (meth)acrylic acid alkyl ester having a linear, branched or cyclic alkyl group with a carbon number of 2 to 16 (preferably from 2 to 10 and more preferably from 4 to 8).

The acrylic acid alkyl ester is preferably an acrylic acid alkyl ester having an alkyl group with a carbon number of 2 to 14 (more preferably from 4 to 9). Specific preferred examples thereof include an acrylic acid alkyl ester having a linear or branched alkyl group, such as butyl acrylate (n-butyl acrylate), isobutyl acrylate, s-butyl acrylate, isoamyl acrylate, hexyl acrylate, heptyl acrylate, octyl acrylate, 2-ethylhexyl acrylate, isooctyl acrylate, nonyl acrylate, and isononyl acrylate. Among these, butyl acrylate, 2-ethylhexyl acrylate and isooctyl acrylate are particularly preferred.

The methacrylic acid alkyl ester is preferably a methacrylic acid alkyl ester having an alkyl group with a carbon number of 2 to 16 (more preferably from 2 to 10). Specific examples thereof include a methacrylic acid alkyl ester having a linear or branched alkyl group, such as ethyl methacrylate, propyl methacrylate, isopropyl methacrylate, n-butyl methacrylate, isobutyl methacrylate, s-butyl methacrylate, and t-butyl methacrylate; and an alicyclic methacrylic acid alkyl ester such as cyclohexyl methacrylate, bornyl methacrylate and isobornyl methacrylate.

One of these (meth)acrylic acid alkyl esters may be used alone, or two or more thereof may be used in combination.

The ratio of the (meth)acrylic acid alkyl ester to all raw material monomers (the entire amount (100 wt %) of the monomer mixture) of the acrylic emulsion polymer A is not particularly limited but is preferably 50 wt % or more, more preferably 60 wt % or more, and still more preferably 70 wt % or more.

The raw material monomer of the acrylic emulsion polymer A may contain, if desired, a copolymerizable monomer for the purpose of, for example, stabilizing emulsion particles, enhancing adherence of the pressure-sensitive adhesive layer to a substrate, or enhancing initial adhesiveness to an adherend. As for the copolymerizable monomer, one monomer is used alone, or two or more monomers are used in combination.

The copolymerizable monomer is not particularly limited, but examples thereof include a carboxyl group-containing monomer such as acrylic acid, methacrylic acid, itaconic acid, maleic acid, fumaric acid, crotonic acid, carboxyethyl acrylate, and carboxypentyl acrylate; and a hydroxyl group-containing monomer such as 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate.

Furthermore, the copolymerizable monomer includes an epoxy group-containing monomer such as glycidyl (meth)acrylate; and a polyfunctional monomer such as trimethylolpropane tri(meth)acrylate and divinylbenzene, which are used for the purpose of enhancing crosslinking within an emulsion particle and cohesive force.

Above all, in view of mechanical stability of the acrylic emulsion polymer A, the copolymerizable monomer is preferably an acrylic acid or a methacrylic acid.

The ratio of the copolymerizable monomer to all raw material monomers (the entire amount (100 wt %) of the monomer mixture) of the acrylic emulsion polymer A is not particularly limited but is preferably 60 wt % or less (for example, from 0.5 to 60 wt %) and more preferably 25 wt % or less (for example, from 0.7 to 25 wt %).

The acrylic emulsion polymer A is obtained by emulsion-polymerizing the above-described raw material monomers (monomer mixture) by using an emulsifier and a polymerization initiator.

The emulsifier for use in the emulsion polymerization includes an emulsifier not containing a radical polymerizable functional group (hereinafter, sometimes referred to as “non-reactive emulsifier”) and an emulsifier containing a radical polymerizable functional group (hereinafter, sometimes referred to as “reactive emulsifier”). Incidentally, one of the emulsifiers may be used alone, or two or more thereof may be used in combination. Also, as the emulsifier, a non-reactive emulsifier and a reactive emulsifier may be used in combination.

Examples of the non-reactive emulsifier include an anionic emulsifier such as alkylsulfate, alkylsulfonate, and dialkylsulfosuccinate; and a nonionic emulsifier such as polyoxyethylene alkylphenol ether, polyoxyalkyl ether, and polyoxyethylene carboxylic acid ester.

Furthermore, as the non-reactive emulsifier, examples of the anion type include sodium dodecylbenzenesulfonate, sodium polyoxyethylene alkyl ether sulfate, and sodium alkylsulfonate, and examples of the nonionic type include a polyoxyethylene alkyl type, a polyoxyethylene alkyl ether type, a polyoxyethylene glycol type, and a polyoxyethylene propylene glycol type.

The reactive emulsifier is an emulsifier having at least one radical polymerizable functional group in the molecule (per molecule). As the reactive emulsifier, for example, one member or two or more members selected from various reactive emulsifiers having a radical polymerizable functional group such as vinyl group, propenyl group, isopropenyl group, vinyl ether group (vinyloxy group), and allyl ether group (allyloxy group) are used. In the case where the emulsifier for use in the emulsion polymerization is a reactive emulsifier, the emulsion is incorporated into a polymer, and contamination derived from the emulsifier is reduced in the formed pressure-sensitive adhesive.

Examples of the reactive emulsifier include a reactive emulsifier having a configuration (or a reactive emulsifier corresponding to the configuration) in which a radical polymerizable functional group (radical reactive group) such as propenyl group and allyl ether group is introduced into a nonionic anionic emulsifier (an anionic emulsifier having a nonionic hydrophilic group) such as sodium polyoxyethylene alkyl ether sulfate, ammonium polyoxyethylene alkylphenyl ether sulfate, sodium polyoxyethylene alkylphenyl ether sulfate, and sodium polyoxyethylene alkyl sulfosuccinate.

The amount used (blending amount) of the emulsifier is not particularly limited, but is preferably from 0.1 to 7 parts by weight and more preferably from 0.5 to 4 parts by weight per 100 parts by weight as the total weight of the raw material monomer (all raw material monomers, the entire amount of the monomer mixture) constituting the acrylic emulsion polymer A. If the amount used exceeds 7 parts by weight, cohesive force of the pressure-sensitive adhesive may be reduced to increase the amount of contamination on an adherend, or contamination due to the emulsifier itself may occur. Furthermore, the cohesive force of the pressure-sensitive adhesive layer may be decreased, or foaming may be caused to produce a defect and thereby deteriorate the coating appearance. On the other hand, if the amount used is less than 0.1 parts by weight, stable emulsification may not be maintained in some cases.

The polymerization initiator for use in the emulsion polymerization of the acrylic emulsion polymer A is not particularly limited, but examples thereof include an azo-based polymerization initiator such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine); persulfate such as potassium persulfate and ammonium persulfate; peroxide-based polymerization initiator such as benzoyl peroxide, t-butyl hydroperoxide and hydrogen peroxide; and redox-type initiator by a combination of a peroxide and a reducing agent, such as a combination of a peroxide and ascorbic acid (e.g., combination of aqueous hydrogen peroxide and ascorbic acid), a combination of a peroxide and an iron(II) salt (e.g., combination of aqueous hydrogen peroxide and an iron(II) salt), and a combination of a persulfate and sodium hydrogensulfite. One of these polymerization initiators may be used alone, or two or more thereof may be used in combination.

The blending amount (amount used) of the polymerization initiator may be appropriately determined according to the kind of the initiator or the raw material monomer and is not particularly limited, but, the blending amount is preferably from 0.001 to 0.1 part by weight per 100 parts by weight as the total weight of the raw material monomer (all raw material monomers, the entire amount of the monomer mixture) constituting the acrylic emulsion polymer A.

In the polymerization of the acrylic emulsion polymer A, a chain transfer agent may be used so as to adjust the molecular weight of the acrylic emulsion polymer. As the chain transfer agent, a conventionally known or commonly employed chain transfer agent can be used. Examples thereof include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One chain transfer agent may be used alone, or two or more thereof may be used in combination. The blending amount (amount used) of the chain transfer agent is not particularly limited but is preferably from 0.001 to 0.1 parts by weight per 100 parts by weight as the total weight of the raw material monomer (all raw material monomers, the entire amount of the monomer mixture) constituting the acrylic emulsion polymer A.

The polymerization method for the emulsion polymerization of the acrylic emulsion polymer A is not particularly limited, and examples thereof include batch polymerization, continuous dropping polymerization and portionwise dropping polymerization.

The content of the acrylic emulsion polymer A in the aqueous dispersion pressure-sensitive adhesive composition is not particularly limited but is preferably from 50 to 99.8 wt % and more preferably from 70 to 99.5 wt %, based on the entire amount of solid matters (total weight (100 wt %) of solid matters) of the aqueous dispersion pressure-sensitive adhesive composition. That is, the aqueous dispersion pressure-sensitive adhesive composition is preferably an aqueous dispersion acrylic pressure-sensitive adhesive composition.

The isocyanate compound B contained in the aqueous dispersion pressure-sensitive adhesive composition is a compound containing, in the molecule, one or more electron beam reactive groups and one or more isocyanate groups. As for the isocyanate compound B, one compound is used alone, or two or more compounds are used in combination.

The electron beam reactive group in the isocyanate compound B indicates a group (functional group) capable of producing a reaction point (active site) upon irradiation with an electron beam.

Examples of the electron beam reactive group include an ionic reactive group capable of producing an anion or a cation as an active species upon irradiation with an active energy ray; and a radical polymerizable group capable of producing a free radical as an active species upon irradiation with an active energy ray. Of these, in view of activity efficiency, a radical polymerizable group is preferred, and an unsaturated bond group (a radical polymerizable unsaturated bond group) is more preferred. Here, the unsaturated bond group (radical polymerizable unsaturated bond group) indicates a group (functional group) having an unsaturated bond (carbon-carbon double bond, ethylenically unsaturated bond).

Examples of the unsaturated bond group include acryloyl group, methacryloyl group and alkenyl group. The alkenyl group is preferably vinyl group or allyl group. Above all, the unsaturated bond group is preferably acryloyl group or methacryloyl group.

The number of electron beam reactive groups in the isocyanate compound B is not particularly limited but is preferably 1 or more (for example, from 1 to 30) and more preferably 1 or 2. If the number of electron beam reactive groups exceeds 30, the pressure-sensitive adhesive may be excessively increased in elastic modulus after irradiation with an electron beam and become too hard in some cases. When the pressure-sensitive adhesive becomes too hard, this cannot be used as a pressure-sensitive adhesive.

The isocyanate group in the isocyanate compound B may be an ordinary isocyanate group (non-blocked isocyanate group) or a blocked isocyanate group (isocyanate in blocked form). The blocked isocyanate group (isocyanate in blocked form) is a group capable of suppressing reactivity of an isocyanate group under normal conditions by masking (protecting) the isocyanate group with another functional group but, on the other hand, capable of deblocking under heating to reproduce an active isocyanate group. In the present invention, the isocyanate compound B in which the isocyanate group is an ordinary isocyanate group is sometimes referred to as a “non-blocked isocyanate compound B”, and the isocyanate compound B in which the isocyanate group is a blocked isocyanate group is sometimes referred to as a “blocked isocyanate compound B”.

The number of isocyanate groups in the non-blocked isocyanate compound B, or the number of blocked isocyanate groups in the blocked isocyanate compound B is not particularly limited but is preferably 1 or more (for example, from 1 to 50) and more preferably 1. If the number exceeds 50, the molecular weight of the compound may become too large to reduce compatibility. Also, reaction with water may readily occur to cause a problem such as foaming.

In particular, from the standpoint of more enhancing the anchoring force of the pressure-sensitive adhesive layer of the present invention to a substrate, the isocyanate compound B is preferably a compound B having one or two electron beam reactive groups and one isocyanate group (or blocked isocyanate group).

Examples of the non-blocked isocyanate compound B include an isocyanatoalkyl (meth)acrylate such as isocyanatoethyl (meth)acrylate, isocyanatopropyl (meth)acrylate and isocyanatobutyl (meth)acrylate.

Furthermore, the non-blocked isocyanate compound B includes a compound formed by a conventionally known method. Examples of such a compound formed by a conventionally known method include a reaction product between a monoalcohol having a radical polymerizable unsaturated bond and an isocyanate compound described below.

The monoalcohol having a radical polymerizable unsaturated bond is not particularly limited, but examples thereof include hydroxyethyl acrylate, hydroxyethyl methacrylate, hydroxypropyl acrylate, hydroxypropyl methacrylate, hydroxybutyl acrylate, hydroxybutyl methacrylate, and allyl alcohol.

The isocyanate compound is preferably a compound having two or more isocyanate groups per molecule, and examples thereof include aliphatic polyisocyanate such as ethylene diisocyanate, tetramethylene diisocyanate, hexamethylene diisocyanate (HDI), and dodecamethylene diisocyanate; alicyclic polyisocyanate such as cyclopentylene diisocyanate, cyclohexylene diisocyanate, isophorone diisocyanate (IPDI), dicyclohexylmethane-4,4′-diisocyanate (hydrogenated MDI), and methylcyclohexylene diisocyanate (hydrogenated TDI); aromatic polyisocyanate such as 1,3- or 1,4-phenylene diisocyanate, 2,4- or 2,6-tolylene diisocyanate (TDI), 2,2′-, 2,4′- or 4,4′-diphenylmethane diisocyanate (MDI), 3-chloro-4-methylphenyl diisocyanate, and 4-chlorophenyl diisocyanate; aromatic-aliphatic polyisocyanate such as m- or p-xylylene diisocyanate (XDI) and α,α,α′,α′-tetramethylxylylene diisocyanate (TMXDI); polymethylene polyphenyl polyisocyanate; isocyanate adduct such as trimethylolpropane/tolylene diisocyanate trimer adduct (trade name, “CORONATE L”, produced by Nippon Polyurethane Industry Co., Ltd.), trimethylolpropane/hexamethylene diisocyanate trimer adduct (trade name, “CORONATE HL”, produced by Nippon Polyurethane Industry Co., Ltd.), and isocyanurate form of hexamethylene diisocyanate (trade name, “CORONATE HX”, produced by Nippon Polyurethane Industry Co., Ltd.); and a modified product of each of the above-described polyisocyanates.

The non-blocked isocyanate compound B also includes a commercial product of the compound B having a radical polymerizable unsaturated bond and an isocyanate group in the molecule. Examples of such a commercial product include 2-isocyanatoethyl methacrylate (trade name, “KARENZ MOI”, produced by Showa Denko K.K., a compound having one radical polymerizable unsaturated bond and one isocyanate group in the molecule), and 1,1-bis(acryloyloxymethyl)ethyl isocyanate (trade name, “KARENZ BEI”, produced by Showa Denko K.K., a compound having two radical polymerizable unsaturated bonds and one isocyanate group in the molecule).

The blocked isocyanate compound B includes a compound formed by a conventionally known method. Examples of such a compound formed by a conventionally known method include a compound obtained, for example, by stirring a isocyanate compound having a radical polymerizable unsaturated bond and a blocking agent at a temperature of approximately from 0 to 200° C. in a solvent, and separating the reaction product by known separation purification means such as concentration, filtration, extraction, crystallization and distillation.

Examples of the isocyanate compound having a radical polymerizable unsaturated bond, which is used at the formation of the blocked isocyanate compound B, include a reaction product of the above-described isocyanatoalkyl (meth)acrylate or monoalcohol having a radical polymerizable unsaturated bond with an isocyanate compound.

Examples of the blocking agent include lactam such as ε-caprolactam, δ-valerolactam and γ-butyrolactam; oxime such as methyl ethyl ketoxime, methyl isobutyl ketoxime, methyl isoamyl ketoxime, acetophenone oxime, benzophenone oxime, and cyclohexanone oxime; phenol such as phenol, cresol, ethylphenol, butylphenol, nonylphenol, catechol, and nitrophenol; alcohol such as methanol, ethanol, isopropyl alcohol, butanol, cyclohexanol, and trimethylolpropane; mercaptan such as butylmercaptan and dodecylmercaptan; active methylene compound such as dimethyl malonate, diethyl malonate, methyl acetoacetate, ethyl acetoacetate, and acetylacetone; amide such as acetanilide and acetic acid amide; imide such as succinic acid imide and maleic acid imide; pyrazole such as 3,5-dimethylpyrazole; triazole such as 1,2,4-triazole; sulfite such as sodium bisulfite; and N,N′-diarylformamidine such as N,N′-diphenylformamidine, N,N′-bis(2-methylphenyl)formamidine, N,N′-bis(3-methylphenyl)formamidine, N,N′-bis(4-methylphenyl)formamidine, and N,N′-bis(3,5-dimethylphenyl)formamidine. One of these blocking agents may be used alone, or two or more thereof may be used in combination. Among the blocking agents above, N,N′-diarylformamidine is preferred from the standpoint that the pot life of the pressure-sensitive adhesive composition is long and a crosslinking reaction proceeds at a relatively low temperature (for example, from 80 to 120° C.).

The blocked isocyanate compound B also includes a commercial product of the compound having a radical polymerizable unsaturated bond and a blocked isocyanate group in the molecule. Examples of such a commercial product include 2-[(3,5-dimethylpyrazolyl)carboxyamino]ethyl methacrylate (trade name, “KARENZ MOI-BP”, produced by Showa Denko K.K., a compound having one radical polymerizable unsaturated bond and one blocked isocyanate group in the molecule, a compound having a pyrazole-type blocked isocyanate group such as 3,5-dimethylpyrazolyl), and 2-(0-[1′-methylpropylideneamino]carboxyamino)ethyl methacrylate (trade name, “KARENZ MOI-BM”, produced by Showa Denko K.K., a compound having one radical polymerizable unsaturated bond and one blocked isocyanate group in the molecule, a compound having an oxime-type blocked isocyanate group such as methyl ethyl ketone oxime).

The content of the isocyanate compound B in the aqueous dispersion pressure-sensitive adhesive composition is not particularly limited but is preferably from 0.1 to 30 parts by weight and more preferably from 0.3 to 10 parts by weight, per 100 parts by weight of the acrylic emulsion polymer A. If the content is less than 0.1 part by weight, anchoring property of the pressure-sensitive adhesive layer to a substrate may not be enhanced in some cases, whereas if the content exceeds 30 parts by weight, the pressure-sensitive adhesive layer may become very high elastic, failing in obtaining sufficient pressure-sensitive adhesive property in some cases.

The aqueous dispersion pressure-sensitive adhesive composition may contain various additives as long as the effects of the present invention are not impaired. Examples of various additives include a crosslinking agent, a pigment, a filler, a leveling agent, a dispersant, a plasticizer, a stabilizer, an antioxidant, an ultraviolet absorber, an ultraviolet stabilizer, an antiaging agent, and an antiseptic. One of the additives may be used alone, or two or more thereof may be used in combination.

The aqueous dispersion pressure-sensitive adhesive composition is produced by mixing the above-described acrylic emulsion polymer A and the above-described isocyanate compound B. Additionally, as necessary, various additives may be blended. The mixing method is not particularly limited and a conventionally known or commonly employed mixing method for an emulsion is used, and, for example, stirring with a stirrer is preferred. The stirring conditions are not particularly limited, but, for example, the temperature is preferably from 10 to 50° C. and more preferably from 20 to 35° C., the stirring time is preferably from 5 to 30 minutes and more preferably from 10 to 20 minutes, and the rotation speed in the stirring is preferably from 10 to 2,000 rpm and more preferably from 30 to 1,000 rpm.

The pressure-sensitive adhesive layer of the present invention is formed by curing, by irradiation with an electron beam, the pre-irradiation pressure-sensitive adhesive layer obtained by heating and drying an aqueous dispersion pressure-sensitive adhesive composition layer formed of the above-described aqueous dispersion pressure-sensitive adhesive composition.

The thickness of the pressure-sensitive adhesive layer of the present invention is not particularly limited but is preferably from 1 to 1,000 μm and more preferably from 3 to 200 μm. The pressure-sensitive adhesive layer of the present invention may have a single-layer structure or a laminate structure.

### (Substrate)

The substrate of the pressure-sensitive adhesive sheet of the present invention is not particularly limited as long as it is an appropriate tissue material. Preferred examples of the substrate include a plastic substrate, a fiber substrate, a paper substrate, and a metal substrate. Also, one substrate may be used, or two or more substrates may be used in combination.

In particular, in the fields of electronic devices and optics, since low contamination property and thickness accuracy as well as transparency are required of the pressure-sensitive adhesive sheet, the substrate is preferably a plastic substrate.

The material of the plastic substrate is not particularly limited, and examples thereof include resin (transparent resin) such as polyolefin (polyolefin resin) such as polypropylene and polyethylene; polyester (polyester resin) such as polyethylene terephthalate (PET); polycarbonate; polyamide; polyimides; acryl; polystyrene; acetate; polyethersulfone; and triacetyl cellulose. One of these resins may be used, or two or more thereof may be used in combination. Among the resins above, polyester resin and polyolefin resin are preferred, and PET, polypropylene and polyethylene are more preferred in view of productivity and formability. That is, the substrate is preferably a polyester film or a polyolefin film, and more preferably a PET film, a polypropylene film, or a polyethylene film.

The thickness of the substrate is not particularly limited but in view of handleability and heat resistance in each step, the thickness is preferably from 5 to 300 μm and more preferably from 10 to 200 μm.

For the purpose of enhancing adherence to the pressure-sensitive adhesive layer, the substrate may be subjected to an appropriate surface treatment such as physical treatment, for example, corona treatment or plasma treatment, or chemical treatment, for example, treatment with primer.

In the pressure-sensitive adhesive sheet of the present invention, a release film (separator) may be stacked on the pressure-sensitive adhesive layer for the purpose of protecting the pressure-sensitive adhesive layer. The release film is not particularly limited and includes a known release film. A release film in which a release layer is formed on at least one surface of a release film substrate is preferred.

The release film substrate is not particularly limited, and examples thereof include a plastic film, a paper, a foam and a metal foil. Above all, the release film substrate is preferably a plastic film. The thickness of the release film substrate is not particularly limited and may be appropriately selected according to the purpose. Examples of the material of the plastic film as the release film substrate include polyester such as polyethylene terephthalate, polyolefin such as polypropylene and ethylene-propylene copolymer, and thermoplastic resin such as polyvinyl chloride. The plastic film may be either an unstretched film or a stretched (uniaxially stretched or biaxially stretched) film.

The release layer formed on the release film substrate is not particularly limited, and examples thereof include a release layer formed of a silicone-based release agent, a release layer formed of a fluorine-based release agent, and a release layer formed of a long-chain alkyl-based release agent. The release layer may be formed on only one surface of the release film substrate or may be formed on both surfaces of the release film substrate.

The pressure-sensitive adhesive sheet of the present invention may be in a wound-roll form obtained by winding the sheet into a roll. Specifically, the pressure-sensitive adhesive sheet of the present invention may be in a wound-roll form obtained by winding the sheet into a roll in the state of the pressure-sensitive adhesive surface being protected with a release film (separator), or a wound-roll form obtained by subjecting the back surface of the substrate to a release treatment and winding the sheet into a roll while letting the pressure-sensitive adhesive surface be protected with the release-treated back surface of the substrate. Incidentally, the release agent used for the release treatment of the back surface of the substrate is not particularly limited, and examples thereof include a silicone-based release agent, a fluorine-based release agent and a long chain alkyl-based release agent.

The method for producing the pressure-sensitive adhesive sheet of the present invention is not particularly limited, but the pressure-sensitive adhesive sheet of the present invention is preferably produced by irradiating a pre-irradiation pressure-sensitive adhesive layer which is provided on at least one side of a substrate and formed by heating and drying the aqueous dispersion pressure-sensitive adhesive composition, with an electron beam to cure the pre-irradiation pressure-sensitive adhesive layer and thereby forming the pressure-sensitive adhesive layer of the present invention. Because, it is presumed that the isocyanate compound B reacts with both the acrylic emulsion polymer A and the substrate in the course of irradiating the pre-irradiation pressure-sensitive adhesive layer with an electron beam and this allows development of sufficient anchoring property between the pressure-sensitive adhesive layer and the substrate.

The method for producing the pressure-sensitive adhesive sheet of the present invention is preferably, for example, a method comprising at least the following steps 1, 2 and 3, in which a pressure-sensitive adhesive sheet is obtained by forming a pressure-sensitive adhesive layer on at least one side of a substrate:

step 1: a step of forming an aqueous dispersion pressure-sensitive adhesive composition layer from an aqueous dispersion pressure-sensitive adhesive composition containing an acrylic emulsion polymer A and a compound B having, in the molecule, one or more electron beam reactive groups and one or more isocyanate groups,

step 2: a step of heating and drying the aqueous dispersion pressure-sensitive adhesive composition layer to form a pre-irradiation pressure-sensitive adhesive layer, and

step 3: a step of irradiating the pre-irradiation pressure-sensitive adhesive layer provided on at least one side of the substrate with an electron beam to form the pressure-sensitive adhesive layer.

In the method for producing the pressure-sensitive adhesive sheet of the present invention, a direct process may be used, or a transfer process may be used.

In the case of using a direct process as the method for producing the pressure-sensitive adhesive sheet of the present invention, the production method of the pressure-sensitive adhesive sheet is preferably, for example, a method comprising: forming, on at least one side of a substrate, an aqueous dispersion pressure-sensitive adhesive composition layer from the aqueous dispersion pressure-sensitive adhesive composition; then heating and drying the aqueous dispersion pressure-sensitive adhesive composition layer to form a pre-irradiation pressure-sensitive adhesive layer; and further irradiating the pre-irradiation pressure-sensitive adhesive layer with an electron beam to form a pressure-sensitive adhesive layer. In this production method, a layer (pre-irradiation pressure-sensitive adhesive layer) formed by heating and drying an aqueous dispersion pressure-sensitive adhesive composition is provided on at least one side of a substrate by heating and drying an aqueous dispersion pressure-sensitive adhesive layer formed on at least one side of the substrate.

In the case of using a transfer process as the method for producing the pressure-sensitive adhesive sheet of the present invention, the production method of the pressure-sensitive adhesive sheet is preferably, for example, a method comprising: forming, on a separator (process separator), an aqueous dispersion pressure-sensitive adhesive composition layer from the aqueous dispersion pressure-sensitive adhesive composition; heating and drying the aqueous dispersion pressure-sensitive adhesive composition layer to form a pre-irradiation pressure-sensitive adhesive layer; then transferring the pre-irradiation pressure-sensitive adhesive layer onto at least one side of a substrate; and thereafter, irradiating the pre-irradiation pressure-sensitive adhesive layer with an electron beam to form a pressure-sensitive adhesive layer.

At the time of providing a coated layer (aqueous dispersion pressure-sensitive adhesive composition layer) by using the above-described aqueous dispersion pressure-sensitive adhesive composition, a conventionally known coating method may be used. Examples of the coater which may be used include a gravure roll coater, a reverse roll coater, a kiss roll coater, a dip roll coater, a bar coater, a knife coater, a spray coater, a comma coater, and a direct coater.

The heating and drying above includes, for example, heating and drying in an atmosphere at a temperature of 80 to 170° C. (preferably from 80 to 160° C.) for 0.5 to 20 minutes (preferably from 1 to 10 minutes).

Although this is not particularly limited, for example, a conventionally known apparatus such as circulating hot air oven may be used for the heating and drying.

The irradiation energy of the electron beam applied to the pre-irradiation pressure-sensitive adhesive layer is not particularly limited but is preferably from 5 to 5,000 kGy, more preferably from 10 to 300 kGy, and still more preferably from 20 to 200 kGy. If the irradiation energy is less than 5 kGy, the pressure-sensitive adhesive layer may be insufficiently cured, or anchoring force of the pressure-sensitive adhesive layer to the substrate may be inadequate in some cases. On the other hand, if the irradiation energy exceeds 5,000 kGy, the pressure-sensitive adhesive layer or substrate may be significantly damaged to cause deterioration of the pressure-sensitive adhesive sheet in some cases.

The pressure-sensitive adhesive sheet of the present invention has the pressure-sensitive adhesive layer of the present invention and therefore, is excellent in low contamination property by causing no contamination on the adherend surface from the pressure-sensitive adhesive layer at the time of applying to an adherend. Also, adhesiveness to an adherend is excellent. Furthermore, the pressure-sensitive adhesive sheet of the present invention is excellent in anchoring property between the substrate and the pressure-sensitive adhesive layer of the present invention and therefore, is excellent in the adhesive deposit prevention by causing no adhesive deposit even when the pressure-sensitive adhesive sheet is applied to an adherend and then separated from the adherend. In addition, the pressure-sensitive adhesive sheet of the present invention is excellent in resistance to lifting or peeling by causing no lifting or peeling from the adherend during use.

The pressure-sensitive adhesive sheet of the present invention has the above-described characteristics and therefore, is suitably used for an optical product where low contamination property is important, or for a double-coated pressure-sensitive adhesive sheet. The usage for an optical product includes surface protection (for example, a surface protective film for an optical member) or fixing of an optical member (for example, an optical plastic, an optical glass or an optical film) such as polarizing plate, retardation plate, antireflection plate, wavelength plate, optically compensatory film, and luminance enhancing film, constituting a panel of a liquid crystal display, an organic electroluminescence (organic EL), a field emission display or the like. Furthermore, the pressure-sensitive adhesive sheet of the present invention is used, for example, to protect a surface or prevent breakage during the production of a microfabricated component such as semiconductor, circuit, various printed boards, various masks, and lead frame, or used for removal of an extraneous material or the like, or for masking.

### EXAMPLES

The present invention is described in greater detail below by referring to Examples, but the present invention is not limited to these Examples.

### Example 1

### Formation of Aqueous Dispersion Acrylic Pressure-Sensitive Adhesive Composition

A monomer emulsion was prepared by emulsifying and dispersing 48.7 parts by weight of butyl acrylate, 2 parts by weight of acrylic acid, 3.9 parts by weight of an ether sulfate-type nonreactive anionic surfactant (trade name, “LATEMUL E118-B”, produced by Kao Corporation, active ingredient: 26 wt %), 0.025 parts by weight of lauryl mercaptan (produced by Wako Pure Chemical Industries, Ltd., 1-dodecanethiol), and 12.6 parts by weight of water, by means of an emulsifying machine.

Into a reaction vessel equipped with a condenser, a nitrogen inlet tube, a thermometer, and a stirring device, 22.8 parts by weight of water and 0.051 parts by weight of a water-soluble azo-based polymerization initiator (trade name, “VA-057”, produced by Wako Pure Chemical Industries, Ltd.) were weighed and the monomer emulsion obtained above was added dropwise over 4 hours under nitrogen purging. The inner bath temperature was kept at 60±1° C. during the polymerization. After 4 hours following the initiation of polymerization, ripening was effected by further continuing the reaction for 3 hours while keeping the inner bath temperature at 60±1° C. Thereafter, the reaction product was adjusted to a pH of 8 with aqueous ammonia in a concentration of 10 wt % to form a liquid dispersion of an acrylic emulsion polymer.

Subsequently, to the liquid dispersion obtained above, 5 parts by weight of a compound having a radical polymerizable unsaturated bond and an isocyanate group (trade name, “KARENZ MOI”, produced by Showa Denko K.K., 2-methacryloyloxyethyl isocyanate) was added to prepare an aqueous dispersion acrylic pressure-sensitive adhesive composition.

### (Formation of Pressure-Sensitive Adhesive Layer and Production of Pressure-Sensitive Adhesive Sheet)

Thereafter, the aqueous dispersion acrylic pressure-sensitive adhesive composition obtained above was applied (coated) on a PET film (trade name, “LUMIRROR S-10”, produced by Toray Industries, Inc., thickness: 38 μm) by using an applicator (manufactured by Tester Sangyo Co., Ltd.) so as to be a thickness after drying of 20 μm, to thereby obtain a sheet having a laminate configuration consisting of the PET film and an aqueous dispersion acrylic pressure-sensitive adhesive composition layer.

The sheet above was then placed into a circulating hot air oven and dried at 120° C. for 2 minutes. The sheet after the completion of drying was irradiated with an electron beam with dose of irradiation of 30 kGy by using an EB irradiation apparatus (trade name, “EC250/30/20 mA”, manufactured EYE Electron Beam Co., Ltd.), to thereby obtain a substrate-attached pressure-sensitive adhesive sheet having a laminate configuration of PET film/pressure-sensitive adhesive layer.

### Examples 2 to 6

Aqueous dispersion acrylic pressure-sensitive adhesive compositions were prepared in the same manner as in Example 1 except for changing the amount of the compound having a radical polymerizable unsaturated bond and an isocyanate group (trade name, “KARENZ MOI”, produced by Showa Denko K.K., 2-methacryloyloxyethyl isocyanate) to the amount shown in Table 1. The amount of the compound having a radical polymerizable unsaturated bond and an isocyanate group in each Example is shown in the column of MOI Amount of Table 1.

Thereafter, formation of a pressure-sensitive adhesive layer and production of a pressure-sensitive adhesive sheet were performed in the same manner as in Example 1 except for changing the dose of the electron beam irradiation applied by the EB irradiation apparatus to the dose of irradiation shown in Table 1. The dose of electron beam irradiation in each Example is shown in the column of Dose of Irradiation of Table 1.

### Comparative Examples 1 and 2

Aqueous dispersion acrylic pressure-sensitive adhesive compositions were prepared in the same manner as in Example 1 except for changing the amount of the compound having a radical polymerizable unsaturated bond and an isocyanate group (trade name, “KARENZ MOI”, produced by Showa Denko K.K., 2-methacryloyloxyethyl isocyanate) to the amount shown in Table 1. The amount of the compound having a radical polymerizable unsaturated bond and an isocyanate group in each Comparative Example is shown in the column of MOI Amount of Table 1.

Thereafter, the aqueous dispersion acrylic pressure-sensitive adhesive composition obtained above was applied (coated) on a PET film (trade name, “LUMIRROR S-10”, produced by Toray Industries, Inc., thickness: 38 μm) by using an applicator (manufactured by Tester Sangyo Co., Ltd.) so as to be a thickness afger drying of 20 μm, to thereby obtain a sheet having a laminate configuration consisting of the PET film and an aqueous dispersion acrylic pressure-sensitive adhesive composition layer.

The sheet above was then placed into a circulating hot air oven and dried at 120° C. for 2 minutes to obtain a substrate-attached pressure-sensitive adhesive sheet having a laminate configuration of PET film/pressure-sensitive adhesive layer.

### Comparative Example 3

An aqueous dispersion acrylic pressure-sensitive adhesive composition was prepared in the same manner as in Example 1 except for not adding the compound having a radical polymerizable unsaturated bond and an isocyanate group (trade name, “KARENZ MOI”, produced by Showa Denko K.K., 2-methacryloyloxyethyl isocyanate).

Thereafter, the aqueous dispersion acrylic pressure-sensitive adhesive composition obtained above was applied (coated) on a PET film (trade name, “LUMIRROR S-10”, produced by Toray Industries, Inc., thickness: 38 μm) by using an applicator (manufactured by Tester Sangyo Co., Ltd.) so as to be a thickness after drying of 20 μm, to thereby obtain a sheet having a laminate configuration consisting of the PET film and an aqueous dispersion acrylic pressure-sensitive adhesive composition layer.

The sheet above was then placed into a circulating hot air oven and dried at 120° C. for 2 minutes to obtain a substrate-attached pressure-sensitive adhesive sheet having a laminate configuration of PET film/pressure-sensitive adhesive layer.

### Comparative Examples 4, 5 and 6

Aqueous dispersion acrylic pressure-sensitive adhesive compositions were prepared in the same manner as in Example 1 except for not adding the compound having a radical polymerizable unsaturated bond and an isocyanate group (trade name, “KARENZ MOI”, produced by Showa Denko K.K., 2-methacryloyloxyethyl isocyanate).

Thereafter, formation of a pressure-sensitive adhesive layer and production of a pressure-sensitive adhesive sheet were performed in the same manner as in Example 1 except for changing the dose of electron beam irradiation applied by the EB irradiation apparatus to the dose of irradiation shown in Table 1. The dose of electron beam irradiation in each Comparative Example is shown in the column of Dose of Irradiation of Table 1.

### (Evaluation)

With respect to Examples and Comparative Examples, the relative anchoring force of the pressure-sensitive adhesive layer was determined by measuring the anchoring force. The results of the relative anchoring force are shown in Table 1.

### (Relative Anchoring Force)

A test piece of 20 mm in width and 100 mm in length was obtained from the substrate-attached pressure-sensitive adhesive sheet obtained in each of Examples and Comparative Examples.

Subsequently, the surface on the pressure-sensitive adhesive layer side of the test piece was laminated on an acrylic pressure-sensitive adhesive tape (trade name, “No. 315”, produced by Nitto Denko Corporation) by using a laminator (small laminator, manufactured by Tester Sangyo Co., Ltd.) under the conditions of a lamination pressure of 0.25 MPa and a lamination speed of 0.3 m/min. The acrylic pressure-sensitive adhesive tape laminated to the test piece was allowed to stand in an environment of 23° C. and 50% RH for 30 minutes.

After the standing, using the acrylic pressure-sensitive adhesive tape laminated to the test piece, a 180° peel test was performed under the following conditions, and the delamination force (=anchoring force) (N/20 mm) between the substrate of the test piece and the pressure-sensitive adhesive layer of the test piece was measured.

### Measurement Conditions in 180° Peel Test:

Peel angle: 180°

Tensile speed: 300 mm/min

Test environment: normal state (in an environment of 23° C. and 50% RH)

The relative anchoring force was determined according to the following formula:

Relative anchoring force=(anchoring force of test piece irradiated with electron beam)/(anchoring force of test piece not irradiated with electron beam)

The relative anchoring force is a relative value of the anchoring force of the test piece irradiated with an electron beam, assuming that the anchoring force of the test piece not irradiated with an electron beam is 1.

The relative anchoring force is determined using substrate-attached pressure-sensitive adhesive sheets being common each other except for the presence or absence of electron beam irradiation. The substrate-attached pressure-sensitive adhesive sheet of Comparative Example 1 corresponds to a substrate-attached pressure-sensitive adhesive sheet in the case where the electron beam irradiation was not conducted in Examples 1 to 3. The substrate-attached pressure-sensitive adhesive sheet of Comparative Example 2 corresponds to a substrate-attached pressure-sensitive adhesive sheet in the case where the electron beam irradiation was not conducted in Examples 4 to 6. The substrate-attached pressure-sensitive adhesive sheet of Comparative Example 3 corresponds to a substrate-attached pressure-sensitive adhesive sheet in the case where the electron beam irradiation was not conducted in Comparative Examples 4 to 6.

TABLE 1

| | MOI Amount | Dose of Irradiation | Relative |
|---|---|---|---|
| | [parts by weight] | [kGy] | Anchoring Force |
| Example 1 | 5 | 30 | 7.0 |
| Example 2 | 5 | 50 | 6.9 |
| Example 3 | 5 | 100 | 7.3 |
| Example 4 | 1 | 30 | 2.1 |
| Example 5 | 1 | 50 | 2.0 |
| Example 6 | 1 | 100 | 2.2 |
| Comparative | 5 | 0 | — |
| Example 1 | | | |
| Comparative | 1 | 0 | — |
| Example 2 | | | |
| Comparative | 0 | 0 | — |
| Example 3 | | | |
| Comparative | 0 | 30 | 1.0 |
| Example 4 | | | |
| Comparative | 0 | 50 | 1.0 |
| Example 5 | | | |
| Comparative | 0 | 100 | 0.9 |
| Example 6 | | | |

While the present invention has been described in detail with reference to the specific embodiments thereof, it will be apparent to one skilled in the art that various changes and modifications can be made therein without departing from the spirit and scope of the present invention.

The present application is based on the Japanese Patent Application No. 2011-099881 filed on Apr. 27, 2011, and the entire contents thereof are incorporated herein by reference. All references cited herein are incorporated in their entirety.

What is claimed is:

1. A pressure-sensitive adhesive sheet comprising a substrate and a pressure-sensitive adhesive layer formed on at least one side of the substrate,
wherein the pressure-sensitive adhesive layer is obtained by: heating and drying an aqueous dispersion pressure-sensitive adhesive composition containing an acrylic emulsion polymer A and a compound B having, in the molecule, one or more electron beam reactive groups and one or more isocyanate groups to form a pre-irradiation pressure-sensitive adhesive layer; and irradiating the pre-irradiation pressure-sensitive adhesive layer with an electron beam.

2. The pressure-sensitive adhesive sheet according to claim 1, wherein said electron beam reactive group is a radical polymerizable group.

3. The pressure-sensitive adhesive sheet according to claim 2, wherein said radical polymerizable group is an unsaturated bond group.

4. The pressure-sensitive adhesive sheet according to claim 1, wherein the aqueous dispersion pressure-sensitive adhesive composition contains the compound B in an amount of from 0.1 to 30 parts by weight based on 100 parts by weight of the acrylic emulsion polymer A.

5. The pressure-sensitive adhesive sheet according to claim 1, wherein the aqueous dispersion pressure-sensitive adhesive composition contains the compound B in an amount of from 0.3 to 10 parts by weight based on 100 parts by weight of the acrylic emulsion polymer A.

6. A method for producing a pressure-sensitive adhesive sheet by forming a pressure-sensitive adhesive layer on at least one side of a substrate, wherein the production method comprising the following steps 1, 2 and 3:
step 1: a step of forming an aqueous dispersion pressure-sensitive adhesive composition layer from an aqueous dispersion pressure-sensitive adhesive composition containing an acrylic emulsion polymer A and a compound B having, in the molecule, one or more electron beam reactive groups and one or more isocyanate groups;
step 2: a step of heating and drying said aqueous dispersion pressure-sensitive adhesive composition layer to form a pre-irradiation pressure-sensitive adhesive layer; and
step 3: a step of irradiating said pre-irradiation pressure-sensitive adhesive layer provided on at least one side of the substrate with an electron beam to form the pressure-sensitive adhesive layer.

7. A method for producing a pressure-sensitive adhesive sheet, comprising:
forming, on at least one side of a substrate, an aqueous dispersion pressure-sensitive adhesive composition layer from an aqueous dispersion pressure-sensitive adhesive composition containing an acrylic emulsion polymer A and a compound B having, in the molecular, one or more electron beam reactive groups and one or more isocyanate groups;
heating and drying said aqueous dispersion pressure-sensitive adhesive composition layer to form a pre-irradiation pressure-sensitive adhesive layer; and
irradiating the pre-irradiation pressure-sensitive adhesive layer with an electron beam to form a pressure-sensitive adhesive layer.

8. A method for producing a pressure-sensitive adhesive sheet, comprising:
forming, on a separator, an aqueous dispersion pressure-sensitive adhesive composition layer from an aqueous dispersion pressure-sensitive adhesive composition containing an acrylic emulsion polymer A and a compound B having, in the molecular, one or more electron beam reactive groups and one or more isocyanate groups;
heating and drying said aqueous dispersion pressure-sensitive adhesive composition layer to form a pre-irradiation pressure-sensitive adhesive layer;
transferring the pre-irradiation pressure-sensitive adhesive layer onto at least one side of a substrate; and thereafter
irradiating the pre-irradiation pressure-sensitive adhesive layer with an electron beam to form a pressure-sensitive adhesive layer.
